(19) United States
(12) Patent Application Publication
(10) Pub. No.: US 2016/0239864 A1
(43) Pub. Date: Aug. 18, 2016

(54) METHOD AND APPARATUS FOR DETECTING CHEAT ON PAGE VIEWS OF WEB PAGE

(71) Applicant: Beijing Gridsum Technology Co., Ltd., Beijing (CN)

(72) Inventors: Guosheng QI, Beijing (CN); Chong WU, Beijing (CN); Yanlong MA, Beijing (CN); Tao YANG, Beijing (CN); Fei DAI, Beijing (CN); Dele YU, Beijing (CN)

(21) Appl. No.: 15/139,096

(22) Filed: Apr. 26, 2016

Related U.S. Application Data
(63) Continuation-in-part of application No. PCT/CN2014/089724, filed on Oct. 28, 2014.

(30) Foreign Application Priority Data
Oct. 29, 2013 (CN) 201310523151.0

(51) Int. Cl. G06Q 30/02; H04L 29/12; H04L 12/26; H04L 29/08

(52) U.S. Cl. CPC G06Q 30/0248; H04L 67/02; H04L 61/2007; H04L 43/16

(57) ABSTRACT

The disclosure discloses a method and apparatus for detecting cheat on web page views. The method for detecting cheat on web page views includes that: the page views of a target web page is acquired; it is judged whether the page views satisfies a predetermined condition; if the page views satisfies the predetermined condition, visit source information of the target web page is acquired; and according to the visit source information, it is judged whether the page views of the target web page is cheated. By judging whether the acquired page views of the target web page satisfies the predetermined condition, when the page views satisfies the predetermined condition, it is determined that the page views of the target web page is cheated. By means of the disclosure, the problem of inaccurate identification of cheat on the page views of the web page is solved, thereby achieving an effect of accurately identifying the cheat on the page views of the target web page.

### CROSS REFERENCE TO RELATED APPLICATIONS

This application is a continuation-in-part of PCT International Application No. PCT/CN2014/089724, filed Oct. 28, 2014, which claimed priority from Chinese Patent Application No. 201310523151.0, filed Oct. 29, 2013, all of which is hereby incorporated herein by reference.

### TECHNICAL FIELD OF THE DISCLOSURE

The disclosure relates to the field of internet, and in particular to a method and apparatus for detecting cheat on web page views.

### BACKGROUND OF THE DISCLOSURE

As more and more advertisers choose the internet to put advertisements, network advertisement expenses increase progressively year by year. The quantitative evaluation and third-party authority detection of an internet advertisement putting effect have been rigidly required by the advertisers. However, different from a traditional media industry, an internet advertisement industry has a higher technical threshold, a more complicated data structure, more evaluation indicator dimensions and a higher technical putting requirement. When internet advertisements are cheated, it is difficult to identify the cheat of the internet advertisements due to these characteristics, and therefore the interests of the advertisers are damaged.

Some terms above are described below.

The cheat of an internet advertisement is cheat of media (such as Sina and other websites, serving as site masters for completing putting of advertisements) to brush advertisement traffic.

An advertiser is an advertisement releaser, is a merchant selling or promoting own products and service on line, and is a provider of an affiliate marketing advertisement. Any merchant promoting and selling the products or service can serve as the advertiser. The advertiser releases an advertisement, and pays the site master according to the total number of specified marketing effects in advertisements completed by the site master and a unit effect cost.

Currently, behaviours of cheat on hits exist in a great number of bidding advertisement businesses and search ranking service operated by a network search service provider. It is estimated, by an insider, that more than twenty percent of total hits of search engine advertisements are non-existent. Generally, a cheat method with respect to hits is classified into an automatic method and a manual method. According to the automatic method, a robot capable of automatically executing a series of script programs for cyclic hits and page refreshing operations continuously hits Banners on a website and a search result page. According to the manual method, cheap labour is employed with relatively low cost to manually hit various advertisement links according to a huge-crowd strategy, this cheat mode difficult to defect in a technical way is on the rise nowadays, and some abuzz network selection cheat events are associated with this cheat mode actually.

The most common skill for the cheat of the internet advertisement is that an iframe is embedded into a web page. The method generally includes: embedding an iframe has a size of 0*0 or 1*1 into an own web page, namely an iframe invisible to a user. Other pages are opened via the iframe, and therefore the user opens a web page which is not expected to be opened, and traffic is brushed under the condition of invisibility to the user. A traditional anti-cheat method is unlikely to effectively identify this cheat mode adopting the huge-crowd strategy and embedding the iframe, which makes a hit cheat situation difficult to effectively inhibit.

The cheat of the internet advertisement, in the final analysis, is a cheat behaviour implemented by the site master to brush the page views. Thus, a third-party authority detection organization detects the cheat behaviours about brushing of the page views of an advertisement web page, and the benefits of the advertisers can be effectively protected. However, in the conventional art, solutions capable of identifying cheat on the page views of the web page hardly exist.

An effective solution is not proposed currently for the problem in the conventional art of inaccurate identification of cheat on the page views of the web page.

### SUMMARY OF THE DISCLOSURE

The disclosure is mainly intended to provide a method and apparatus for detecting cheat on web page views, which are used to solve the problem in the conventional art of inaccurate identification of cheat on the page views of the web page.

In order to achieve the aim, according to one aspect of the disclosure, a method for detecting cheat on web page views is provided. The method for detecting cheat on web page views according to the disclosure may include that: the page views of a target web page is acquired; it is judged whether the page views satisfies a predetermined condition; if the page views satisfies the predetermined condition, visit source information of the target web page is acquired; and according to the visit source information, it is judged whether the page views of the target web page is cheated.

Furthermore, the step that the page views of the target web page is acquired may include that historical page views and current page views to the target web page are acquired. The step that it is judged whether the page views satisfies the predetermined condition may include that: a ratio of historical page views to current page views is acquired; it is judged whether the ratio exceeds a first set threshold value; if the ratio exceeds the first set threshold value, it is determined that the page views satisfies the predetermined condition; and if the ratio does not exceed the first set threshold value, it is determined that the page views does not satisfy the predetermined condition.

Furthermore, the step that the page views of the target web page is acquired may include that historical page views and current page views to the target web page are acquired. The step that it is judged whether the page views satisfies the predetermined condition may include that: a difference between historical page views and current page views is acquired; it is judged whether the difference exceeds a second set threshold value; if the difference exceeds the second set threshold value, it is determined that the page views satisfies the predetermined condition; and if the difference does not exceed the second set threshold value, it is determined that the page views does not satisfy the predetermined condition.

Furthermore, the step that the visit source information of the target web page is acquired may include that: a source code of the target web page is acquired; a detection code is added to the source code so as to acquire visit Internet Protocol (IP) addresses of the target web page; and the visit IP addresses are taken as the visit source information. The step that it is judged whether the page views of the target web page is cheated according to the visit source information may include that: a first number of visits of a first visit IP address among the visit IP addresses is acquired, wherein the first visit IP address is a visit IP address, with most page views of the target web page, among the visit IP addresses; a ratio of the first page views of the page views is calculated; it is judged whether the ratio of the first page views of the page views exceeds a third set threshold value; if the ratio of the first page views of the page views exceeds the third set threshold value, it is determined that the page views of the target web page is cheated; and if the ratio of the first page views of the page views does not exceed the third set threshold value, it is determined that the page views of the target web page is not cheated.

Furthermore, the step that it is determined that the page views of the target web page is cheated may include that: visit retention time of the first visit IP address is acquired; it is judged whether the visit retention time exceeds a fourth set threshold value; and if the visit retention time does not exceed the fourth set threshold value, it is determined that the page views of the target web page is cheated.

Furthermore, before the page views of the target web page is acquired, the method for detecting cheat on web page views may further include that: a source code of the target web page is acquired; it is detected whether an iframe has a size of 0*0 or 1*1 exists in the source code; and if the iframe does not exist in the source code, the page views of the target web page is acquired.

In order to achieve the aim, according to another aspect of the disclosure, an apparatus for detecting cheat on web page views is provided. The apparatus for detecting cheat on web page views according to the disclosure may include: a first acquisition unit, configured to acquire the page views of a target web page; a first judgement unit, configured to judge whether the page views satisfies a predetermined condition; a second acquisition unit, configured to acquire visit source information of the target web page when the page views satisfies the predetermined condition; and a second judgement unit, configured to judge whether the page views of the target web page is cheated according to the visit source information.

Furthermore, the first acquisition unit may be further configured to acquire historical page views and current page views to the target web page, wherein the first judgement unit includes: a first acquisition module, configured to acquire a ratio of historical page views to current page views; a first judgment module, configured to judge whether the ratio exceeds a first set threshold value; and a first determination module, configured to determine that the page views satisfies the predetermined condition when the ratio exceeds the first set threshold value, and determine that the page views does not satisfy the predetermined condition when the ratio does not exceed the first set threshold value.

Furthermore, the first acquisition unit may be further configured to acquire historical page views and current page views to the target web page, wherein the first judgement unit includes: a second acquisition module, configured to acquire a difference between historical page views and current page views; a second judgment module, configured to judge whether the difference exceeds a second set threshold value; and a second determination module, configured to determine that the page views satisfies the predetermined condition when the difference exceeds the second set threshold value, and determine that the page views does not satisfy the predetermined condition when the difference does not exceed the second set threshold value.

Furthermore, the second acquisition unit may include: a third acquisition module, configured to acquire a source code of the target web page; a fourth acquisition module, configured to add a detection code to the source code so as to acquire visit IP addresses of the target web page; and a generation module, configured to take the visit IP addresses as the visit source information. The second judgment unit may include: a fifth acquisition module, configured to acquire a first number of visits of a first visit IP address among the visit IP addresses, wherein the first visit IP address is a visit IP address, with most page views of the target web page, among the visit IP addresses; a calculation module, configured to calculate a ratio of the first page views of the page views; a third judgment module, configured to judge whether the ratio of the first page views of the page views exceeds a third set threshold value; and a third determination module, configured to determine that the page views of the target web page is cheated when the ratio of the first page views of the page views exceeds the third set threshold value, and determine that the page views of the target web page is not cheated when the ratio of the first page views of the page views does not exceed the third set threshold value.

Furthermore, the third determination module may include: an acquisition sub-module, configured to acquire visit retention time of the first visit IP address; a judgment sub-module, configured to judge whether the visit retention time exceeds a fourth set threshold value; and a determination sub-module, configured to determine that the page views of the target web page is cheated when the visit retention time does not exceed the fourth set threshold value, and determine that the page views of the target web page is not cheated when the visit retention time exceeds the fourth set threshold value.

Furthermore, the apparatus for detecting cheat on web page views may further include: a third acquisition unit, configured to acquire a source code of the target web page before the page views of the target web page is acquired; a detection unit, configured to detect whether an iframe has a size of 0*0 or 1*1 exists in the source code; and a determination unit, configured to acquire the page views of the target web page when the iframe does not exist in the source code.

By means of the disclosure, the method for detecting cheat on web page views includes that: the page views of the target web page is acquired; it is judged whether the page views satisfies the predetermined condition; if the page views satisfies the predetermined condition, the visit source information of the target web page is acquired; and according to the visit source information, it is judged whether the page views of the target web page is cheated. By judging whether the acquired page views of the target web page satisfies the predetermined condition, when the page views satisfies the predetermined condition, it is determined that the page views of the target web page is suspected to be cheated, the visit source information of the target web page is further acquired, it is further judged whether the page views of the target web page is cheated according to the visit source information, the accuracy of detection for the cheat on the page views of the target web page is improved by analysing and determining the source information of the target web page, and the problem of inaccurate identification of the cheat on the page views of the web page is solved, thereby achieving an effect of accurately identifying the cheat on the page views of the target web page.

### BRIEF DESCRIPTION OF THE DRAWINGS

The drawings forming a part of the disclosure are intended to provide further understanding of the disclosure. The schematic embodiments and descriptions of the disclosure are intended to explain the disclosure, and do not form improper limits to the disclosure. In the drawings:

FIG. 1 is a structural diagram of an apparatus for detecting cheat on web page views according to a first embodiment of the disclosure;

FIG. 2 is a structural diagram of an apparatus for detecting cheat on web page views according to a second embodiment of the disclosure;

FIG. 3 is a structural diagram of an apparatus for detecting cheat on web page views according to a third embodiment of the disclosure;

FIG. 4 is a structural diagram of an apparatus for detecting cheat on web page views according to a fourth embodiment of the disclosure;

FIG. 5 is a structural diagram of an apparatus for detecting cheat on web page views according to a fifth embodiment of the disclosure;

FIG. 6 is a structural diagram of an apparatus for detecting cheat on web page views according to a sixth embodiment of the disclosure;

FIG. 7 is a flowchart of a method for detecting cheat on web page views according to a first embodiment of the disclosure;

FIG. 8 is a flowchart of a method for detecting cheat on web page views according to a second embodiment of the disclosure;

FIG. 9 is a flowchart of a method for detecting cheat on web page views according to a third embodiment of the disclosure;

FIG. 10 is a flowchart of a method for detecting cheat on web page views according to a fourth embodiment of the disclosure;

FIG. 11 is a flowchart of a method for detecting cheat on web page views according to a fifth embodiment of the disclosure; and

FIG. 12 is a flowchart of a method for detecting cheat on web page views according to a sixth embodiment of the disclosure.

### DETAILED DESCRIPTION OF THE EMBODIMENTS

It is important to note that the embodiments of the disclosure and the characteristics in the embodiments can be combined under the condition of no conflicts. The disclosure is described in detail below with reference to the drawings and the embodiments.

An embodiment of the disclosure provides an apparatus for detecting cheat on web page views. Functions of the apparatus are achieved via a computer device.

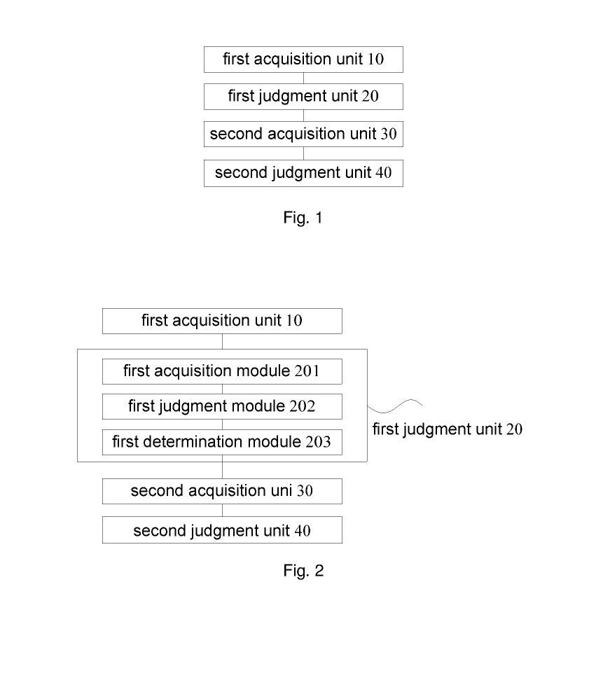

FIG. 1 is a structural diagram of an apparatus for detecting cheat on web page views according to a first embodiment of the disclosure. As shown in FIG. 1, the apparatus for detecting cheat on web page views includes: a first acquisition unit 10, a first judgment unit 20, a second acquisition unit 30 and a second judgment unit 40. The first acquisition unit 10 is configured to acquire the page views of a target web page. The page views, acquired by the first acquisition unit 10, is a total page views of the target web page. The target web page is a web page required to detect cheat on the page views, and the web page can be any one web page in any one website, can be a web page where an advertiser puts an advertisement, and can also be a web page of a product marketed by the advertiser. For example, when the target web page is the web page where the advertiser puts the advertisement, the view of the advertisement put by the advertiser can be obtained by acquiring the page views of the web page. Wherein, the page views can be visit traffic, and can also be a visit hit count. The page views can be historical page views, which is representative of the page views of the target web page within a certain past time period. The page views can also be current page views, which is representative of the page views of the target web page within a certain current time period. The page views can also be historical page views and current page views. The first acquisition unit 10 acquires the page views in a mode of adding a detection code to the target web page so as to detect visit number information such as the visit traffic or visit hit count of the target web page or a mode of directly reading the visit number information such as the visit traffic or visit hit count of the target web page from a log file of the target web page.

The first judgment unit 20 is configured to judge whether the page views satisfies a predetermined condition. The first judgment unit 20 takes the page views of the target web page, acquired according to the first acquisition unit 10, as a judgment basis, and judges whether the page views satisfies the predetermined condition. The predetermined condition can be a change rule of the page views. For example, the predetermined condition is a threshold value during sudden change of the page views, when the page views exceeds the threshold value, it is considered that the page views satisfies the predetermined condition, it can be determined that the page views changes suddenly at this moment, namely current page views changes suddenly with respect to historical page views, and the sudden change can be representative of a trend that current page views increases quickly, and can also be representative of a trend that current page views decreases quickly. In the embodiment, the trend that current page views increases quickly is taken as a sudden change state of the page views. The first judgment unit 20 judges whether the page views satisfies the predetermined condition in order to judge whether the page views is suspected to be cheated. When the page views trends to increase quickly, if the page views in a current day is much greater than the page views in a previous day, it can be determined that the page views of the target web page is suspected to be cheated.

The second acquisition unit 30 is configured to acquire visit source information of the target web page when the page views satisfies the predetermined condition. When the page views satisfies the predetermined condition, it is determined that the page views of the target web page is suspected to be cheated. When the target web page is suspected to be cheated, the second acquisition unit 30 acquires the visit source information of the target web page. The visit source information can be an IP address of a visitor, and can also be visit path information of a visit, for example, which can be a visit to the target web page via hyperlinks of other web pages. The second acquisition unit 30 can acquire the visit path information of the visit and can also acquire the IP address of the visitor by adding a detection code to a source code of the target web page. The visit source information is acquired in order to judge whether the page views of the target web page is cheated.

The second judgment unit 40 is configured to judge whether the page views of the target web page is cheated according to the visit source information. Due to the fact that the page views of the target web page is suspected to be cheated at this moment, after the visit source information of the target web page is acquired, it can be judged whether the page views of the target web page is cheated according to the visit source information. For example, when visit paths of a majority of the visit source information among the acquired visit source information come from some non-mainstream websites or a website hardly found by people (namely a visitor accesses the target web page via some non-mainstream websites or the website hardly found by people), or come from the target web page itself, it can be determined that the page views of the target web page increases in a certain cheat way by means of the connection of some non-mainstream websites or the website hardly found by people to a great extent, or increases in a mode of continuously refreshing the target web page. The cheat possibility is relatively high, and it can be determined that the page views of the target web page is cheated.

According to the embodiment of the disclosure, by judging whether the page views of the target web page, acquired by the first acquisition unit 10, satisfies the predetermined condition, when the page views satisfies the predetermined condition, it is determined that the page views of the target web page is suspected to be cheated, the visit source information of the target web page is further acquired, it is further judged whether the page views of the target web page is cheated according to the visit source information, the accuracy of detection for the cheat on the page views of the target web page is improved by analysing and determining the source information of the target web page, and the effect of accurately identifying the cheat on the page views of the target web page is achieved.

FIG. 2 is a structural diagram of an apparatus for detecting cheat on web page views according to a second embodiment of the disclosure. The apparatus for detecting cheat on web page views according to the embodiment can serve as a preferred implementation mode of the above-mentioned embodiment. As shown in FIG. 2, the apparatus for detecting cheat on web page views includes a first acquisition unit 10, a first judgment unit 20, a second acquisition unit 30 and a second judgment unit 40, wherein the first judgment unit 20 includes a first acquisition module 201, a first judgment module 202 and a first determination module 203. The second acquisition unit 30 and the second judgment unit 40 are identical to the second acquisition unit 30 and the second judgment unit 40 shown in FIG. 1 in function, which do not need to be described in detail here.

The first acquisition unit 10 is further configured to acquire historical page views and current page views to the target web page. Each of historical page views and current page views is the page views of the target web page. Historical page views is representative of the page views of the target web page within a past unit time, and current page views is representative of the page views of the target web page within a current unit time, wherein the past unit time and the current unit time are the same unit time. For example, a day is taken as a time unit, current page views can be the page views of the target web page in the current day, and historical page views can be the page views of the target web page in a previous day. Historical page views and current page views to the target web page can be acquired in a mode of adding a detection code to a source code of the target web page and the like.

The first acquisition module 201 is configured to acquire a ratio of historical page views to current page views. Historical page views and current page views are compared to obtain a ratio. For example, if current page views to the target web page is the page views in a current day, historical page views can be the page views in a previous day, wherein the page views can be visit traffic or a visit hit count. The visit traffic or visit hit count of historical visits is correspondingly compared with the visit traffic or visit hit count of current visits to obtain a ratio which can be a ratio obtained by dividing current page views by historical page views, can be a ratio obtained by dividing historical page views by current page views, and can also be a proportion of current page views beyond historical page views. A change trend of the page views can be seen by acquiring the ratio. For example, the ratio is a ratio obtained by dividing current page views by historical page views, when the ratio is greater than 1, it is shown that current page views is greater than historical page views, and when the ratio is much greater, it is shown that current page views trends to increase quickly.

The first judgment module 202 is configured to judge whether the ratio exceeds a first set threshold value. The first set threshold value can be set according to actual situations. For example, when the ratio is a ratio obtained by dividing current page views by historical page views, the first set threshold value can be set as 1.5, and judging whether the ratio exceeds the first set threshold value refers to judging whether current page views exceeds 1.5 times historical page views; and the first set threshold value can also be set as 2, and judging whether the ratio exceeds the first set threshold value refers to judging whether current page views exceeds 2 times historical page views. When the ratio is representative of a proportion of current page views beyond historical page views, the first set threshold value can be set as 30 percent, and judging whether the ratio exceeds the first set threshold value refers to judging whether an increase rate of current page views exceeds with respect to historical page views exceeds 30 percent.

The first determination module 203 is configured to determine that the page views satisfies the predetermined condition when the ratio exceeds the first set threshold value, and determine that the page views does not satisfy the predetermined condition when the ratio does not exceed the first set threshold value. When the ratio exceeds the first set threshold value, an alarm is given for prompting, it is determined that the page views satisfies the predetermined condition, and the step of acquiring the visit source information of the target web page is executed. For example, when the ratio is a ratio obtained by dividing current page views by historical page views, the first set threshold value can be set as 1.5, and judging whether the ratio exceeds the first set threshold value refers to judging whether current page views exceeds 1.5 times historical page views; and if the ratio exceeds the first set threshold value 1.5, it is determined that the page views satisfies the predetermined condition, current page views trends to change suddenly or increase quickly, it can be determined that there is a certain cheat suspicion, and next analysis is performed, namely the visit source information is acquired. When the ratio is a proportion of current page views beyond historical page views, the first set threshold value can be set as 30 percent, and judging whether the ratio exceeds the first set threshold value refers to judging whether an increase rate of current page views exceeds with respect to historical page views exceeds 30 percent. When the increase rate exceeds 30 percent, it is determined that the page views satisfies the predetermined condition, current page views trends to change suddenly or increase quickly, it can be determined that there is a certain cheat suspicion, and next analysis is performed. When the ratio does not exceed the first set threshold value, if the ratio does not exceed the first set threshold value 1.5 in the above-mentioned example, it is determined that the page views does not satisfy the predetermined condition, the page views does not appear abnormal, and it can be determined that the page views of the target web page is not cheated.

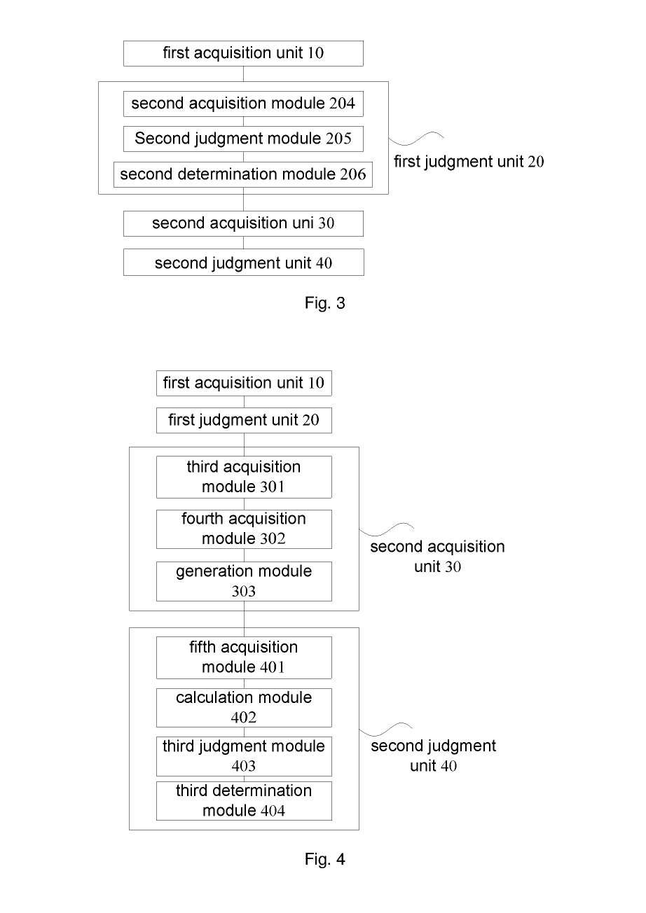

FIG. 3 is a structural diagram of an apparatus for detecting cheat on web page views according to a third embodiment of the disclosure. The apparatus for detecting cheat on web page views according to the embodiment can serve as a preferred implementation mode of the above-mentioned embodiment. As shown in FIG. 3, the apparatus for detecting cheat on web page views includes a first acquisition unit 10, a first judgment unit 20, a second acquisition unit 30 and a second judgment unit 40, wherein the first judgment unit 20 includes a second acquisition module 204, a second judgment module 205 and a second determination module 206. The second acquisition unit 30 and the second judgment unit 40 are identical to the second acquisition unit 30 and the second judgment unit 40 shown in FIG. 1 in function, which do not need to be described in detail here.

The first acquisition unit 10 is further configured to acquire historical page views and current page views to the target web page. Each of historical page views and current page views is the page views of the target web page. Historical page views is representative of the page views of the target web page within a past unit time, and current page views is representative of the page views of the target web page within a current unit time, wherein the past unit time and the current unit time are the same unit time. For example, a day is taken as a time unit, current page views can be the page views of the target web page in the current day, and historical page views can be the page views of the target web page in a previous day. Historical page views and current page views to the target web page can be acquired in a mode of adding a detection code to a source code of the target web page and the like.

The second acquisition module 204 is configured to acquire a difference between historical page views and current page views. A difference is obtained by performing subtraction on historical page views and current page views. For example, if current page views to the target web page is the page views in a current day, historical page views can be the page views in a previous day, wherein the page views can be visit traffic or a visit hit count. A difference is obtained by performing subtraction on the visit traffic or visit hit count of historical visits and the visit traffic or visit hit count of current visits, and the difference can be a difference obtained by subtracting historical page views from current page views and can also be a difference obtained by subtracting current page views from historical page views. A change trend of the page views can be seen by acquiring the difference. For example, the difference is a difference obtained by subtracting historical page views from current page views, when the difference is positive, it is shown that current page views is greater than historical page views, and when the difference is much greater, it is shown that current page views trends to increase quickly.

The second judgment module 205 is configured to judge whether the difference exceeds a second set threshold value. The second set threshold value can be set according to actual situations. For example, when the difference is a difference obtained by subtracting historical page views from current page views, judging whether the difference exceeds the first set threshold value refers to judging whether the page views, namely a proportion of current page views beyond historical page views, exceeds the second set threshold value.

The second determination module 206 is configured to determine that the page views satisfies the predetermined condition when the difference exceeds the second set threshold value, and determine that the page views does not satisfy the predetermined condition when the difference does not exceed the second set threshold value. Judging whether the difference exceeds the second set threshold value refers to judging whether the page views, namely a proportion of current page views beyond historical page views, exceeds the second set threshold value. When the difference exceeds the second set threshold value, an alarm is given for prompting, it is determined that the page views satisfies the predetermined condition, and Step S306 is executed. When the difference exceeds the second set threshold value, it is shown that current page views trends to change suddenly or increase quickly, it can be determined that there is a certain cheat suspicion, and next analysis is performed, namely the visit source information is acquired. When the difference does not exceed the second set threshold value, it is shown that the page views appears abnormal, and it can be determined that the page views of the target web page is not cheated.

FIG. 4 is a structural diagram of an apparatus for detecting cheat on web page views according to a fourth embodiment of the disclosure. The apparatus for detecting cheat on web page views according to the embodiment can serve as a preferred implementation mode of the above-mentioned embodiment. As shown in FIG. 4, the apparatus for detecting cheat on web page views includes a first acquisition unit 10, a first judgment unit 20, a second acquisition unit 30 and a second judgment unit 40, wherein the second acquisition unit 30 includes a third acquisition module 301, a fourth acquisition module 302 and a generation module 303. The second judgment unit 40 includes a fifth acquisition module 401, a calculation module 402, a third judgment module 403 and a third determination module 404. The first acquisition unit 10 and the first judgment unit 20 are identical to the first acquisition unit 10 and the first judgment unit 20 shown in FIG. 1 in function, which do not need to be described in detail here.

The third acquisition module 301 is configured to acquire a source code of the target web page. When the page views satisfies the predetermined condition, the second acquisition unit 30 acquires visit source information of the target web page, wherein the source code of the target web page needs to be acquired via the third acquisition module 301 before the visit source information of the target web page is acquired, and the source code can be configured to acquire the visit source information of the target web page.

The fourth acquisition module 302 is configured to add a detection code to the source code so as to acquire visit IP addresses of the target web page. The detection code is configured to detect the visit source information of the target web page, wherein the visit source information is the visit IP addresses. The visit IP addresses are IP addresses of visitors, and the detection code is added to the source code so as to acquire all visit IP addresses of the target web page. For example, when three visitors visit the target web page, IP addresses of the visitors in the three visits can be acquired by adding the detection code to the target web page, and the three visit IP addresses can be the same IP address or can be different IP addresses.

The generation module 303 is configured to take the visit IP addresses as the visit source information. The IP addresses of the visitors can represent the visit source information, and can represent that the target web page is actually visited by the visitors having the IP addresses. The visit IP addresses are taken as the visit source information in order to further detect a specific situation concerning the page views of the target web page.

The fifth acquisition module 401 is configured to acquire a first number of visits of a first visit IP address among the visit IP addresses, wherein the first visit IP address is a visit IP address, with most page views of the target web page, among the visit IP addresses. The visit IP addresses acquired via the detection code include a plurality of IP addresses, and each IP address will bring a certain page views of the target web page. The first visit IP address can be an IP address of a visitor, with most page views of the target web page, among the visit IP addresses. For example, when the detection code detects that there are three IP addresses visiting the target web page and one of the IP addresses most visits the target web page, the IP address is taken as the first visit IP address. The first number of visits is the page views, carried out by the first visit IP address, to the target web page, and a ratio of the first page views of a total number of visits is greater than the page views of any one of the other visit IP addresses.

The calculation module 402 is configured to calculate a ratio of the first page views of the page views, wherein the page views is the total page views of the target web page, and the ratio of the first page views of the total number of visits is calculated in order to judge a proportion of the first page views of the total number of visits.

The third judgment module 403 is configured to judge whether the ratio of the first page views of the page views exceeds a third set threshold value. The third set threshold value can be set as needed. For example, when the third set threshold value is 0.5, judging whether the ratio of the first page views of the page views exceeds the third set threshold value refers to judging whether the first number of visits exceeds half of the total number of visits.

The third determination module 404 is configured to determine that the page views of the target web page is cheated when the ratio of the first page views of the page views exceeds the third set threshold value, and determine that the page views of the target web page is not cheated when the ratio of the first page views of the page views does not exceed the third set threshold value. As above, when the third set threshold value is 0.5, the ratio of the first page views of the page views exceeds 0.5, it is shown that the first number of visits exceeds half of the total number of visits, it can be considered that the page views of the target web page is realized in a certain cheat way at this moment, and the possibility of cheat on the page views is relatively high. As above, when the third set threshold value is 0.5, the ratio of the first page views of the page views does not exceed 0.5, it is shown that the first number of visits does not exceed half of the total number of visits, it can be considered that the page views of the target web page is normal, and it can be fundamentally determined that the page views of the target web page is not cheated.

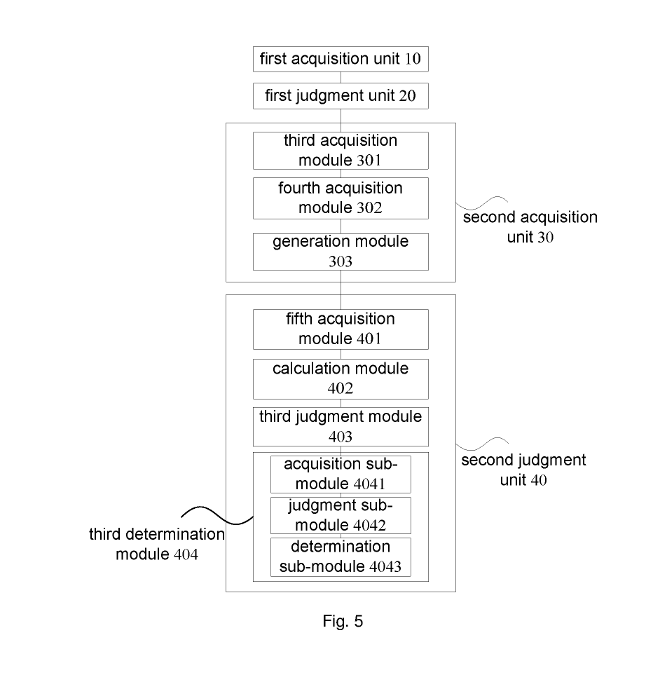

FIG. 5 is a structural diagram of an apparatus for detecting cheat on web page views according to a fifth embodiment of the disclosure. The apparatus for detecting cheat on web page views according to the embodiment can serve as a preferred implementation mode of the above-mentioned embodiment. As shown in FIG. 5, the apparatus for detecting cheat on web page views includes a first acquisition unit 10, a first judgment unit 20, a second acquisition unit 30 and a second judgment unit 40, wherein the second acquisition unit 30 includes a third acquisition module 301, a fourth acquisition module 302 and a generation module 303. The second judgment unit 40 includes a fifth acquisition module 401, a calculation module 402, a third judgment module 403 and a third determination module 404. The third determination module 404 includes an acquisition sub-module 4041, a judgment sub-module 4042 and a determination sub-module 4043. The first acquisition unit 10, the second judgment unit 20 and the second acquisition unit 30 are identical to the first acquisition unit 10, the first judgment unit 20 and the second acquisition unit 30 shown in FIG. 4 in function, the fifth acquisition module 401, the calculation module 402 and the third judgment module 403 in the second judgment unit 40 are identical to the fifth acquisition module 401, the calculation module 402 and the third judgment module 403 shown in FIG. 4 in function, which do not need to be described in detail here.

The acquisition sub-module 4041 is configured to acquire visit retention time of the first visit IP address. The visit retention time is representative of retention time of a visitor on the target web page when visiting the target web page. The first visit IP address has visited the target web page for many times. Thus, the visit retention time may include a plurality of pieces of visit retention time, and acquiring the visit retention time of the first visit IP address refers to acquiring the visit retention time of the first visit IP address in each visit.

The judgment sub-module 4042 is configured to judge whether the visit retention time exceeds a fourth set threshold value. The fourth set threshold value is a visit time threshold value, namely the threshold value is a time value which can be set as needed. Due to the fact that the visit retention time may include a plurality of pieces of visit retention time, judging whether the visit retention time exceeds the fourth set threshold value refers to judging whether each piece of visit retention time exceeds the fourth set threshold value. For example, when the fourth set threshold value is 3 s, it is judged whether each piece of visit retention time of the first visit IP address exceeds 3 s.

The determination sub-module 4043 is configured to determine that the page views of the target web page is cheated when the visit retention time does not exceed the fourth set threshold value, and determine that the page views of the target web page is not cheated when the visit retention time exceeds the fourth set threshold value. If the visit retention time does not exceed the fourth set threshold value, it is shown that the visit retention time of each visit of the first visit IP address does not exceed the fourth set threshold value. Suppose most of pieces of the visit retention time in the first number of visits of the first visit IP address do not exceed the fourth set threshold value, it is considered that the page views of the target web page is cheated. For example, when the fourth set threshold value is 3 s, if most of pieces of the visit retention time in the first number of visits of the first visit IP address do not reach 3 s, it is shown that most of visits in the first number of visits of the first visit IP address are abnormal visits, a form of brushing web page hits is probably adopted, which does not make any common sense, and it is considered that the page views of the target web page is cheated. Similarly, if most of pieces of the visit retention time in the first number of visits of the first visit IP address exceed the fourth set threshold value, it is shown that the first number of visits is the number of normal visits. Thus, it can be considered that the page views of the target web page is not cheated. In the embodiment of the disclosure, most of pieces of the visit retention time in the page views can be visit retention time of the page views, which exceeds a predetermined proportion. For example, the predetermined proportion can be 60 percent.

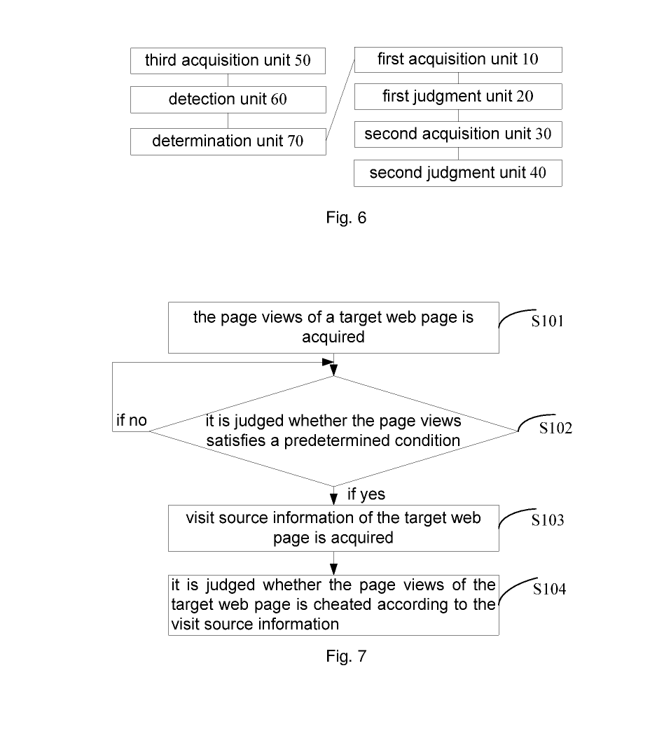

FIG. 6 is a structural diagram of an apparatus for detecting cheat on web page views according to a sixth embodiment of the disclosure. The apparatus for detecting cheat on web page views according to the embodiment can serve as a preferred implementation mode of the above-mentioned embodiment. As shown in FIG. 6, the apparatus for detecting cheat on web page views includes a first acquisition unit 10, a first judgment unit 20, a second acquisition unit 30, a second judgment unit 40, a third acquisition unit 50, a detection unit 60 and a determination unit 70. The first acquisition unit 10, the first judgment unit 20, the second acquisition unit 30 and the second judgment unit 40 are identical to the first acquisition unit 10, the first judgment unit 20, the second acquisition unit 30 and the second judgment unit 40 shown in FIG. 1 in function, which do not need to be described in detail here.

The third acquisition unit 50 is configured to acquire a source code of the target web page before the page views of the target web page is acquired. The source code of the target web page can be captured via a crawler program, the source code can be acquired in other modes, and an organisational structure of the target web page can be obtained in order to detect the target web page.

The detection unit 60 is configured to detect whether an iframe has a size of 0*0 or 1*1 exists in the source code. Due to the fact that the size of the iframe is 0*0 or 1*1, the iframe is invisible. Other pages are opened via the iframe, and therefore a user opens a web page which is not expected to be opened, and traffic or the page views is brushed under the condition of invisibility. An analysis program can be compiled to analyse whether the iframe has a size of 0*0 or 1*1 exists in the source code.

The determination unit 70 is configured to acquire the page views of the target web page when the iframe does not exist in the source code. Due to the fact that the iframe has a size of 0*0 or 1*1 is used for cheating the page views and the page views is brushed under the condition that the user is not informed, when it is detected that the iframe exists in the source code of the target web page, it can be considered that a cheat way is adopted, so it can be determined that the page views of the target web page is cheated. When the iframe does not exist in the source code, next judgment is performed by acquiring the page views of the target web page.

Obviously, those skilled in the art should understand that all modules or all steps in the embodiments of the disclosure can be realized by using a generic calculation apparatus, can be centralized on a single calculation apparatus or can be distributed on a network composed of a plurality of calculation apparatuses. Optionally, they can be realized by using executable program codes of the calculation apparatuses. Thus, they can be stored in a storage apparatus and executed by the calculation apparatuses, or they are manufactured into each integrated circuit module respectively, or a plurality of modules or steps therein are manufactured into a single integrated circuit module. Thus, the disclosure is not limited to a combination of any specific hardware and software.

An embodiment of the disclosure also provides a method for detecting cheat on web page views. The method for detecting cheat on web page views can operate on a computer device. It is important to note that the method for detecting cheat on web page views according to the embodiment of the disclosure can be executed by the apparatus for detecting cheat on web page views according to the embodiment of the disclosure, and the apparatus for detecting cheat on web page views according to the embodiment of the disclosure can also be used for executing the method for detecting cheat on web page views according to the embodiment of the disclosure.

FIG. 7 is a flowchart of a method for detecting cheat on web page views according to a first embodiment of the disclosure. As shown in FIG. 7, the method for detecting cheat on web page views includes the steps as follows.

Step S101: The page views of a target web page is acquired. The acquired number of visits is a total page views of the target web page. The target web page is a web page required to detect cheat on the page views, and the web page can be any one web page in any one website, can be a web page where an advertiser puts an advertisement, and can also be a web page of a product marketed by the advertiser. For example, when the target web page is the web page where the advertiser puts the advertisement, the view of the advertisement put by the advertiser can be obtained by acquiring the page views of the web page. Wherein, the page views can be visit traffic, and can also be a visit hit count. The page views can be historical page views, which is representative of the page views of the target web page within a certain past time period. The page views can also be current page views, which is representative of the page views of the target web page within a certain current time period. The page views can also be historical page views and current page views. The first acquisition unit 10 acquires the page views in a mode of adding a detection code to the target web page so as to detect visit number information such as the visit traffic or visit hit count of the target web page or a mode of directly reading the visit number information such as the visit traffic or visit hit count of the target web page from a log file of the target web page.

Step S102: It is judged whether the page views satisfies a predetermined condition. The first judgment unit 20 takes the page views of the target web page, acquired according to the first acquisition unit 10, as a judgment basis, and judges whether the page views satisfies the predetermined condition. The predetermined condition can be a change rule of the page views. For example, the predetermined condition is a threshold value during sudden change of the page views, when the page views exceeds the threshold value, it is considered that the page views satisfies the predetermined condition, it can be determined that the page views changes suddenly at this moment, namely current page views changes suddenly with respect to historical page views, and the sudden change can be representative of a trend that current page views increases quickly, and can also be representative of a trend that current page views decreases quickly. In the embodiment, the trend that current page views increases quickly is taken as a sudden change state of the page views. The first judgment unit 20 judges whether the page views satisfies the predetermined condition in order to judge whether the page views is suspected to be cheated. When the page views trends to increase quickly, if the page views in a current day is much greater than the page views in a previous day, it can be determined that the page views of the target web page is suspected to be cheated.

Step S103: If the page views satisfies the predetermined condition, visit source information of the target web page is acquired. When the page views satisfies the predetermined condition, it is determined that the page views of the target web page is suspected to be cheated. When the target web page is suspected to be cheated, the second acquisition unit 30 acquires the visit source information of the target web page. The visit source information can be an IP address of a visitor, and can also be visit path information of a visit, for example, which can be a visit to the target web page via hyperlinks of other web pages. By adding a detection code to a source code of the target web page, a website, which is visited at this time and links to the web page, can be acquired, and a visit IP address of the visitor can also be acquired. The visit source information is acquired in order to judge whether the page views of the target web page is cheated.

If the page views does not satisfy the predetermined condition, it can be considered that the page views of the target web page so far is not cheated, it is continuously detected whether the page views of the target web page satisfies the predetermined condition, that is, Step S102 is re-executed until it is judged that the page views satisfies the predetermined condition, and Step S103 of acquiring the visit source information of the target web page is executed.

Step S104: It is judged whether the page views of the target web page is cheated according to the visit source information. Due to the fact that the page views of the target web page is suspected to be cheated at this moment, after the visit source information of the target web page is acquired, it can be judged whether the page views of the target web page is cheated according to the visit source information. For example, when a majority of the visit source information among the acquired visit source information comes from a non-mainstream website or a website hardly found by people, or comes from the target web page itself, it can be determined that the page views of the target web page increases in a certain cheat way by means of the linking of some non-mainstream websites or the website hardly found by people to a great extent, or increases in a mode of continuously refreshing the target web page. The cheat possibility is relatively high, and it can be determined that the page views of the target web page is cheated.

According to the embodiment of the disclosure, by judging whether the page views of the target web page, acquired by the first acquisition unit 10, satisfies the predetermined condition, when the page views satisfies the predetermined condition, it is determined that the page views of the target web page is suspected to be cheated, the visit source information of the target web page is further acquired, it is further judged whether the page views of the target web page is cheated according to the visit source information, the accuracy of detection for the cheat on the page views of the target web page is improved by analysing and determining the source information of the target web page, and the effect of accurately identifying the cheat on the page views of the target web page is achieved.

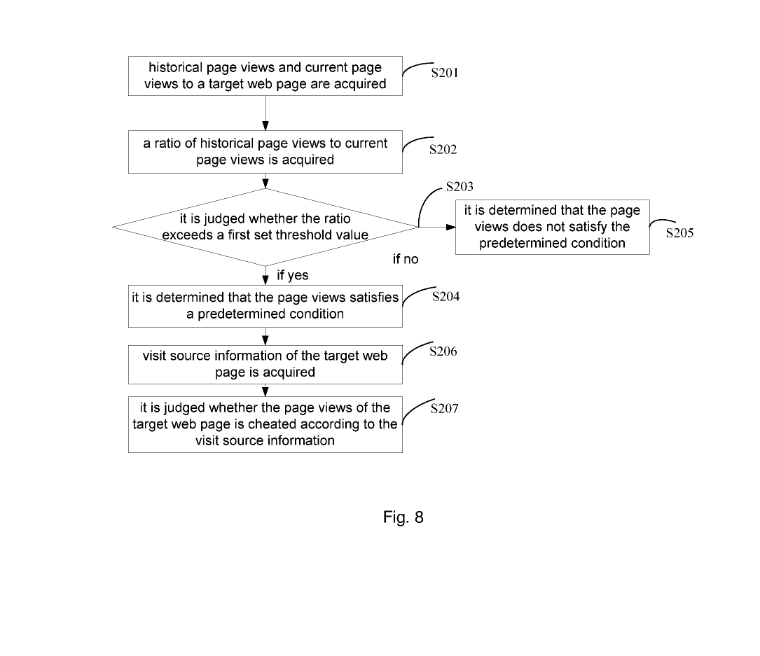

FIG. 8 is a flowchart of a method for detecting cheat on web page views according to a second embodiment of the disclosure. The method for detecting cheat on web page views according to the embodiment can serve as a preferred implementation mode of the method for detecting cheat on web page views according to the above-mentioned embodiment. As shown in FIG. 8, the method for detecting cheat on web page views includes the steps as follows.

Step S201: Historical page views and current page views to a target web page are acquired. Each of historical page views and current page views is the page views of the target web page. Historical page views is representative of the page views of the target web page within a past unit time, and current page views is representative of the page views of the target web page within a current unit time, wherein the past unit time and the current unit time are the same unit time. For example, a day is taken as a time unit, current page views can be the page views of the target web page in the current day, and historical page views can be the page views of the target web page in a previous day. Historical page views and current page views to the target web page can be acquired in a mode of adding a detection code to a source code of the target web page and the like.

Step S202: A ratio of historical page views to current page views is acquired. Historical page views and current page views are compared to obtain a ratio. For example, if current page views to the target web page is the page views in a current day, historical page views can be the page views in a previous day, wherein the page views can be visit traffic or a visit hit count. The visit traffic or visit hit count of historical visits is compared with the visit traffic or visit hit count of current visits to obtain a ratio which can be a ratio obtained by dividing current page views by historical page views, can be a ratio obtained by dividing historical page views by current page views, and can also be a proportion of current page views beyond historical page views. A change trend of the page views can be seen by acquiring the ratio. For example, the ratio is a ratio obtained by dividing current page views by historical page views, when the ratio is greater than 1, it is shown that current page views is greater than historical page views, and when the ratio is much greater, it is shown that current page views trends to increase quickly. If the ratio is a ratio obtained by dividing historical page views by current page views, when the ratio is smaller than 1, it is shown that current page views is greater than historical page views, and when the ratio is much smaller, it is shown that current page views trends to increase quickly.

Step S203: It is judged whether the ratio exceeds a first set threshold value. The first set threshold value can be set according to actual situations. For example, when the ratio is a ratio obtained by dividing current page views by historical page views, the first set threshold value can be set as 1.5, and judging whether the ratio exceeds the first set threshold value refers to judging whether current page views exceeds 1.5 times historical page views; and the first set threshold value can also be set as 2, and judging whether the ratio exceeds the first set threshold value refers to judging whether current page views exceeds 2 times historical page views. When the ratio is representative of a proportion of current page views beyond historical page views, the first set threshold value can be set as 30 percent, and judging whether the ratio exceeds the first set threshold value refers to judging whether an increase rate of current page views exceeds with respect to historical page views exceeds 30 percent.

If the ratio is a ratio obtained by dividing historical page views by current page views, it is judged whether the ratio is smaller than the first set threshold value in Step S203 accordingly.

Step S204: If the ratio exceeds the first set threshold value, it is determined that the page views satisfies the predetermined condition. When the ratio exceeds the first set threshold value, an alarm is given for prompting, it is determined that the page views satisfies the predetermined condition, and Step S206 is executed. For example, when the ratio is a ratio obtained by dividing current page views by historical page views, the first set threshold value can be set as 1.5, and judging whether the ratio exceeds the first set threshold value refers to judging whether current page views exceeds 1.5 times historical page views; and if the ratio exceeds the first set threshold value 1.5, it is determined that the page views satisfies the predetermined condition, current page views trends to change suddenly or increase quickly, it can be determined that there is a certain cheat suspicion, and next analysis is performed, namely the visit source information is acquired. When the ratio is a proportion of current page views beyond historical page views, the first set threshold value can be set as 30 percent, and judging whether the ratio exceeds the first set threshold value refers to judging whether an increase rate of current page views exceeds with respect to historical page views exceeds 30 percent. When the increase rate exceeds 30 percent, it is determined that the page views satisfies the predetermined condition, current page views trends to change suddenly or increase quickly, it can be determined that there is a certain cheat suspicion, and next analysis is performed.

If the ratio is a ratio obtained by dividing historical page views by current page views, it is judged whether the ratio is smaller than the first set threshold value in Step S204 accordingly, and it is determined that the page views satisfies the predetermined condition.

Step S205: If the ratio does not exceed the first set threshold value, it is determined that the page views does not satisfy the predetermined condition. When the ratio does not exceed the first set threshold value, if the ratio does not exceed the first set threshold value 1.5 in the above-mentioned example, it is determined that the page views does not satisfy the predetermined condition, the page views does not appear abnormal, and it can be determined that the page views of the target web page is not cheated.

If the ratio is a ratio obtained by dividing historical page views by current page views, it is judged whether the ratio exceeds the first set threshold value in Step S205 accordingly, and it is determined that the page views does not satisfy the predetermined condition.

Step S206: If the page views satisfies the predetermined condition, the visit source information of the target web page is acquired. When the page views of the target web page satisfies the predetermined condition, it is determined that the page views of the target web page is suspected to be cheated. When the target web page is suspected to be cheated, the second acquisition unit 30 acquires the visit source information of the target web page. The visit source information can be a visit IP address of a visitor, and can also be a website linking to a web page of a visit, for example, which can be a visit to the target web page via hyperlinks of other web pages. By adding a detection code to a source code of the target web page, the website, which is visited at this time and links to the web page, can be acquired, and the visit IP address of the visitor can also be acquired. The visit source information is acquired in order to judge whether the page views of the target web page is cheated.

Step S207: It is judged whether the page views of the target web page is cheated according to the visit source information. Due to the fact that the page views of the target web page is suspected to be cheated at this moment, after the visit source information of the target web page is acquired, it can be judged whether the page views of the target web page is cheated according to the visit source information. For example, when a majority of the visit source information among the acquired visit source information comes from a non-mainstream website or a website hardly found by people, or comes from the target web page itself, it can be determined that the page views of the target web page increases in a certain cheat way by means of the linking of some non-mainstream websites or the website hardly found by people to a great extent, or increases in a mode of continuously refreshing the target web page. The cheat possibility is relatively high, and it can be determined that the page views of the target web page is cheated.

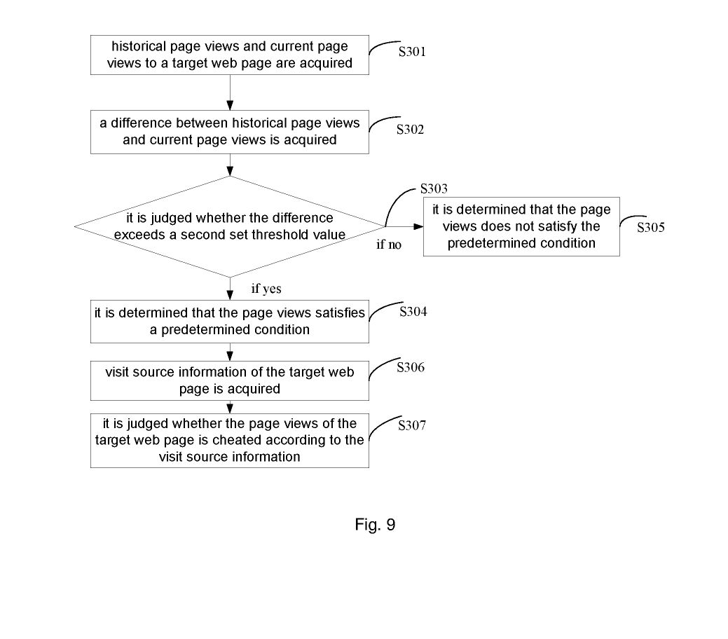

FIG. 9 is a flowchart of a method for detecting cheat on web page views according to a third embodiment of the disclosure. The method for detecting cheat on web page views according to the embodiment can serve as a preferred implementation mode of the method for detecting cheat on web page views according to the above-mentioned embodiment. As shown in FIG. 9, the method for detecting cheat on web page views includes the steps as follows.

Step S301: Historical page views and current page views to a target web page are acquired. Each of historical page views and current page views is the page views of the target web page. Historical page views is representative of the page views of the target web page within a past unit time, and current page views is representative of the page views of the target web page within a current unit time, wherein the past unit time and the current unit time are the same unit time. For example, a day is taken as a time unit, current page views can be the page views of the target web page in the current day, and historical page views can be the page views of the target web page in a previous day. Historical page views and current page views to the target web page can be acquired in a mode of adding a detection code to a source code of the target web page and the like.

Step S302: A difference between historical page views and current page views is acquired. A difference is obtained by performing subtraction on historical page views and current page views. For example, if current page views to the target web page is the page views in a current day, historical page views can be the page views in a previous day, wherein the page views can be visit traffic or a visit hit count. A difference is obtained by performing subtraction on the visit traffic or visit hit count of historical visits and the visit traffic or visit hit count of current visits, and the difference can be a difference obtained by subtracting historical page views from current page views and can also be a difference obtained by subtracting current page views from historical page views. The difference in the embodiment of the disclosure is an absolute value of a difference between historical page views and current page views. A change trend of the page views can be seen by acquiring the difference. For example, the difference is a difference obtained by subtracting historical page views from current page views, when the difference is positive, it is shown that current page views is greater than historical page views, and when the difference is much greater, it is shown that current page views trends to increase quickly.

Step S303: It is judged whether the difference exceeds a second set threshold value. The second set threshold value can be set according to actual situations. For example, when the difference is a difference obtained by subtracting historical page views from current page views, judging whether the difference exceeds the first set threshold value refers to judging whether the page views, namely a proportion of current page views beyond historical page views, exceeds the second set threshold value.

Step S304: If the difference exceeds the second set threshold value, it is determined that the page views satisfies the predetermined condition. Judging whether the difference exceeds the second set threshold value refers to judging whether the page views, namely a proportion of current page views beyond historical page views, exceeds the second set threshold value. When the difference exceeds the second set threshold value, an alarm is given for prompting, it is determined that the page views satisfies the predetermined condition, and Step S306 is executed. When the difference exceeds the second set threshold value, it is shown that current page views trends to change suddenly or increase quickly, it can be determined that there is a certain cheat suspicion, and next analysis is performed, namely the visit source information is acquired.

Step S305: If the difference does not exceed the second set threshold value, it is determined that the page views does not satisfy the predetermined condition. When the difference does not exceed the second set threshold value, it is shown that the page views appears abnormal, and it can be determined that the page views of the target web page is not cheated.

Step S306: If the page views satisfies the predetermined condition, the visit source information of the target web page is acquired. When the page views of the target web page satisfies the predetermined condition, it is determined that the page views of the target web page is suspected to be cheated. When the target web page is suspected to be cheated, the second acquisition unit 30 acquires the visit source information of the target web page. The visit source information can be a visit IP address of a visitor, and can also be a website linking to a web page of a visit, for example, which can be a visit to the target web page via hyperlinks of other web pages. By adding a detection code to a source code of the target web page, the website, which is visited at this time and links to the web page, can be acquired, and the visit IP address of the visitor can also be acquired. The visit source information is acquired in order to judge whether the page views of the target web page is cheated.

Step S307: It is judged whether the page views of the target web page is cheated according to the visit source information. Due to the fact that the page views of the target web page is suspected to be cheated at this moment, after the visit source information of the target web page is acquired, it can be judged whether the page views of the target web page is cheated according to the visit source information. For example, when a majority of the visit source information among the acquired visit source information comes from a non-mainstream website or a website hardly found by people, or comes from the target web page itself, it can be determined that the page views of the target web page increases in a certain cheat way by means of the linking of some non-mainstream websites or the website hardly found by people to a great extent, or increases in a mode of continuously refreshing the target web page. The cheat possibility is relatively high, and it can be determined that the page views of the target web page is cheated.

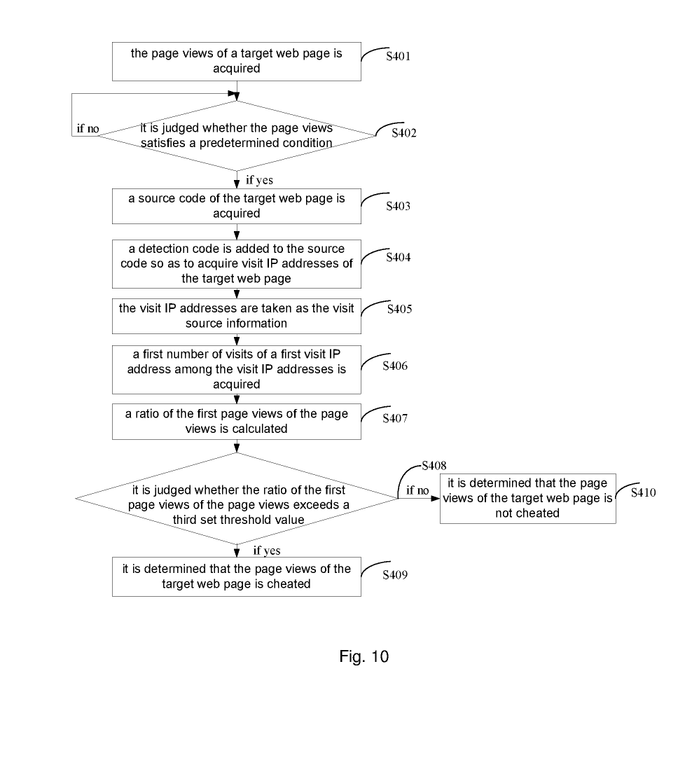

FIG. 10 is a flowchart of a method for detecting cheat on web page views according to a fourth embodiment of the disclosure. The method for detecting cheat on web page views according to the embodiment can serve as a preferred implementation mode of the method for detecting cheat on web page views according to the above-mentioned embodiment. As shown in FIG. 10, the method for detecting cheat on web page views includes the steps as follows.

Step S401: The page views of a target web page is acquired. The target web page is a web page required to detect cheat on the page views, and the web page can be any one web page in any one website, can be a web page where an advertiser puts an advertisement, and can also be a web page of a product marketed by the advertiser. For example, when the target web page is the web page where the advertiser puts the advertisement, the view of the advertisement put by the advertiser can be obtained by acquiring the page views of the web page. Wherein, the page views can be visit traffic, and can also be a visit hit count. The page views can be historical page views, which is representative of the page views of the target web page within a certain past time period. The page views can also be current page views, which is representative of the page views of the target web page within a certain current time period. The page views can also be historical page views and current page views. The first acquisition unit 10 acquires the page views in a mode of adding a detection code to the target web page so as to detect visit number information such as the visit traffic or visit hit count of the target web page or a mode of directly reading the visit number information such as the visit traffic or visit hit count of the target web page from a log file of the target web page.

Step S402: It is judged whether the page views satisfies a predetermined condition. The first judgment unit 20 takes the page views of the target web page, acquired according to the first acquisition unit 10, as a judgment basis, and judges whether the page views satisfies the predetermined condition. The predetermined condition can be a change rule of the page views. For example, the predetermined condition is a threshold value during sudden change of the page views, when the page views exceeds the threshold value, it is considered that the page views satisfies the predetermined condition, it can be determined that the page views changes suddenly at this moment, namely current page views changes suddenly with respect to historical page views, and the sudden change can be representative of a trend that current page views increases quickly, and can also be representative of a trend that current page views decreases quickly. In the embodiment, the trend that current page views increases quickly is taken as a sudden change state of the page views. The first judgment unit 20 judges whether the page views satisfies the predetermined condition in order to judge whether the page views is suspected to be cheated.

Step S403: If the page views satisfies the predetermined condition, a source code of the target web page is acquired. When the page views satisfies the predetermined condition, visit source information of the target web page is acquired, wherein the source code of the target web page needs to be acquired before the visit source information of the target web page is acquired, and the source code can be configured to acquire the visit source information of the target web page.

If the page views does not satisfy the predetermined condition, it can be considered that the page views of the target web page so far is not cheated, and it is continuously detected whether the page views of the target web page satisfies the predetermined condition.

When the page views trends to increase quickly, if the page views in a current day is much greater than the page views in a previous day, it can be determined that the page views of the target web page is suspected to be cheated. Otherwise, it can be considered that the page views of the target web page is not cheated.

Step S404: A detection code is added to the source code so as to acquire visit IP addresses of the target web page. The detection code is configured to detect the visit source information of the target web page, wherein the visit source information is the visit IP addresses. The visit IP addresses are IP addresses of visitors, and the detection code is added to the source code so as to acquire all visit IP addresses of the target web page. For example, when three visitors visit the target web page, IP addresses of the visitors in the three visits can be acquired by adding the detection code to the target web page, and the three visit IP addresses can be the same IP address or can be different IP addresses.

Step S405: The visit IP addresses are taken as the visit source information. The IP addresses of the visitors can represent the visit source information, and can represent that the target web page is actually visited by the visitors having the IP addresses. The visit IP addresses are taken as the visit source information in order to further detect a specific situation concerning the page views of the target web page.

Step S406: A first number of visits of a first visit IP address among the visit IP addresses is acquired, wherein the first visit IP address is a visit IP address, with most page views of the target web page, among the visit IP addresses. The visit IP addresses acquired via the detection code include a plurality of IP addresses, and each IP address will bring a certain page views of the target web page. The first visit IP address can be an IP address of a visitor, with most page views of the target web page, among the visit IP addresses. For example, when the detection code detects that there are three IP addresses visiting the target web page and one of the IP addresses most visits the target web page, the IP address is taken as the first visit IP address. The first number of visits is the page views, carried out by the first visit IP address, to the target web page, and a ratio of the first page views of a total number of visits is greater than the page views of any one of the other visit IP addresses.

Step S407: A ratio of the first page views of the page views is calculated, wherein the page views is the total page views of the target web page, and the ratio of the first page views of the total number of visits is calculated in order to judge a proportion of the first page views of the total number of visits.

Step S408: It is judged whether the ratio of the first page views of the page views exceeds a third set threshold value. The third set threshold value can be set as needed. For example, when the third set threshold value is 0.5, judging whether the ratio of the first page views of the page views exceeds the third set threshold value refers to judging whether the first number of visits exceeds half of the total number of visits.

Step S409: If the ratio of the first page views of the page views exceeds the third set threshold value, it is determined that the page views of the target web page is cheated. As above, when the third set threshold value is 0.5, the ratio of the first page views of the page views exceeds 0.5, it is shown that the first number of visits exceeds half of the total number of visits, it can be considered that the page views of the target web page is realized in a certain cheat way at this moment, and the possibility of cheat on the page views is relatively high.

Step S410: If the ratio of the first page views of the page views does not exceed the third set threshold value, it is determined that the page views of the target web page is not cheated. As above, when the third set threshold value is 0.5, the ratio of the first page views of the page views does not exceed 0.5, it is shown that the first number of visits does not exceed half of the total number of visits, it can be considered that the page views of the target web page is normal, and it can be fundamentally determined that the page views of the target web page is not cheated.

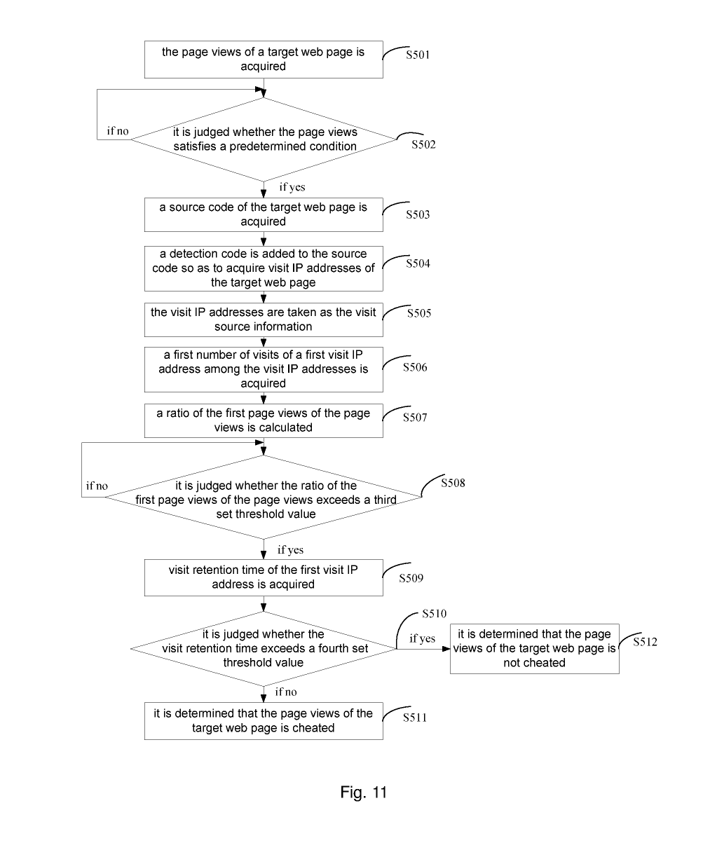

FIG. 11 is a flowchart of a method for detecting cheat on web page views according to a fifth embodiment of the disclosure. The method for detecting cheat on web page views according to the embodiment can serve as a preferred implementation mode of the method for detecting cheat on web page views according to the above-mentioned embodiment. As shown in FIG. 11, the method for detecting cheat on web page views includes the steps as follows.

Step S501: The page views of a target web page is acquired. The target web page is a web page required to detect cheat on the page views, and the web page can be any one web page in any one website, can be a web page where an advertiser puts an advertisement, and can also be a web page of a product marketed by the advertiser. For example, when the target web page is the web page where the advertiser puts the advertisement, the view of the advertisement put by the advertiser can be obtained by acquiring the page views of the web page. Wherein, the page views can be visit traffic, and can also be a visit hit count. The page views can be historical page views, which is representative of the page views of the target web page within a certain past time period. The page views can also be current page views, which is representative of the page views of the target web page within a certain current time period. The page views can also be historical page views and current page views. The first acquisition unit 10 acquires the page views in a mode of adding a detection code to the target web page so as to detect visit number information such as the visit traffic or visit hit count of the target web page or a mode of directly reading the visit number information such as the visit traffic or visit hit count of the target web page from a log file of the target web page.

Step S502: It is judged whether the page views satisfies a predetermined condition. The first judgment unit 20 takes the page views of the target web page, acquired according to the first acquisition unit 10, as a judgment basis, and judges whether the page views satisfies the predetermined condition. The predetermined condition can be a change rule of the page views. For example, the predetermined condition is a threshold value during sudden change of the page views, when the page views exceeds the threshold value, it is considered that the page views satisfies the predetermined condition, it can be determined that the page views changes suddenly at this moment, namely current page views changes suddenly with respect to historical page views, and the sudden change can be representative of a trend that current page views increases quickly, and can also be representative of a trend that current page views decreases quickly. In the embodiment, the trend that current page views increases quickly is taken as a sudden change state of the page views. The first judgment unit 20 judges whether the page views satisfies the predetermined condition in order to judge whether the page views is suspected to be cheated. When the page views trends to increase quickly, if the page views in a current day is much greater than the page views in a previous day, it can be determined that the page views of the target web page is suspected to be cheated.

Step S503: If the page views satisfies the predetermined condition, a source code of the target web page is acquired. When the page views satisfies the predetermined condition, visit source information of the target web page is acquired, wherein the source code of the target web page needs to be acquired before the visit source information of the target web page is acquired, and the source code can be configured to acquire the visit source information of the target web page. If the page views does not satisfy the predetermined condition, it can be considered that the page views of the target web page so far is not cheated, and it is continuously detected whether the page views of the target web page satisfies the predetermined condition.

Step S504: A detection code is added to the source code so as to acquire visit IP addresses of the target web page. The detection code is configured to detect the visit source information of the target web page, wherein the visit source information is the visit IP addresses. The visit IP addresses are IP addresses of visitors, and the detection code is added to the source code so as to acquire all visit IP addresses of the target web page. For example, when three visitors visit the target web page, IP addresses of the visitors in the three visits can be acquired by adding the detection code to the target web page, the three visit IP addresses can be the same IP address or can be different IP addresses, and the visit IP addresses are the visit source information of the target web page.

Step S505: The visit IP addresses are taken as the visit source information. The IP addresses of the visitors can represent the visit source information, and can represent that the target web page is actually visited by the visitors having the IP addresses. The visit IP addresses are taken as the visit source information in order to further detect a specific situation concerning the page views of the target web page.

Step S506: A first number of visits of a first visit IP address among the visit IP addresses is acquired, wherein the first visit IP address is a visit IP address, with most page views of the target web page, among the visit IP addresses. The visit IP addresses acquired via the detection code include a plurality of IP addresses, and each IP address will bring a certain page views of the target web page. The first visit IP address can be an IP address of a visitor, with most page views of the target web page, among the visit IP addresses. For example, when the detection code detects that there are three IP addresses visiting the target web page and one of the IP addresses most visits the target web page, the IP address is taken as the first visit IP address. The first number of visits is the page views, carried out by the first visit IP address, to the target web page, and a ratio of the first page views of a total number of visits is greater than the page views of any one of the other visit IP addresses.

Step S507: A ratio of the first page views of the page views is calculated, wherein the page views is the total page views of the target web page, and the ratio of the first page views of the total number of visits is calculated in order to judge a proportion of the first page views of the total number of visits.

Step S508: It is judged whether the ratio of the first page views of the page views exceeds a third set threshold value. The third set threshold value can be set as needed. For example, when the third set threshold value is 0.5, judging whether the ratio of the first page views of the page views exceeds the third set threshold value refers to judging whether the first number of visits exceeds half of the total number of visits.

Step S509: If the ratio of the first page views of the page views exceeds the third set threshold value, visit retention time of the first visit IP address is acquired. The visit retention time is representative of retention time of a visitor on the target web page when visiting the target web page. The first visit IP address has visited the target web page for many times. Thus, the visit retention time may include a plurality of pieces of visit retention time, and acquiring the visit retention time of the first visit IP address refers to acquiring the visit retention time of the first visit IP address in each visit.

Step S510: It is judged whether the visit retention time exceeds a fourth set threshold value. The fourth set threshold value is a visit time threshold value, namely the threshold value is a time value which can be set as needed. Due to the fact that the visit retention time may include a plurality of pieces of visit retention time, judging whether the visit retention time exceeds the fourth set threshold value refers to judging whether each piece of visit retention time exceeds the fourth set threshold value. For example, when the fourth set threshold value is 3 s, it is judged whether each piece of visit retention time of the first visit IP address exceeds 3 s.

Step S511: If the visit retention time does not exceed the fourth set threshold value, it is determined that the page views of the target web page is cheated. If the visit retention time does not exceed the fourth set threshold value, it is shown that the visit retention time of each visit of the first visit IP address does not exceed the fourth set threshold value. Suppose most of pieces of the visit retention time in the first number of visits of the first visit IP address do not exceed the fourth set threshold value, it is considered that the page views of the target web page is cheated. For example, when the fourth set threshold value is 3 s, if most of pieces of the visit retention time in the first number of visits of the first visit IP address do not reach 3 s, it is shown that most of visits in the first number of visits of the first visit IP address are abnormal visits, a form of brushing web page hits is probably adopted, which does not make any common sense, and it is considered that the page views of the target web page is cheated.

Step S512: If the visit retention time exceeds the fourth set threshold value, it is determined that the page views of the target web page is not cheated. Similarly, if most of pieces of the visit retention time in the first number of visits of the first visit IP address exceed the fourth set threshold value, it is shown that the first number of visits is the number of normal visits. Thus, it can be considered that the page views of the target web page is not cheated.

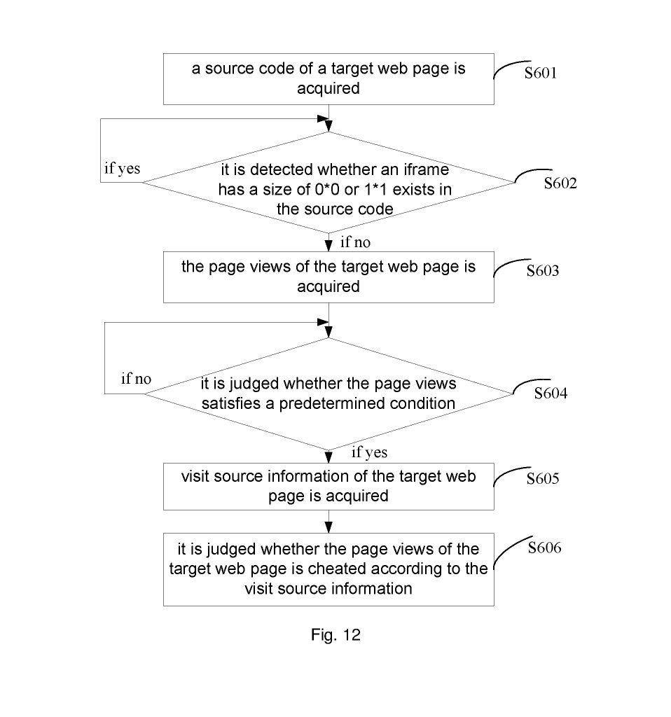

FIG. 12 is a flowchart of a method for detecting cheat on web page views according to a sixth embodiment of the disclosure. The method for detecting cheat on web page views according to the embodiment can serve as a preferred implementation mode of the method for detecting cheat on web page views according to the above-mentioned embodiment. As shown in FIG. 12, the method for detecting cheat on web page views includes the steps as follows.

Step S601: A source code of a target web page is acquired. The source code of the target web page can be captured via a crawler program, the source code can be acquired in other modes, and an organisational structure of the target web page can be obtained in order to detect the target web page.

Step S602: It is detected whether an iframe has a size of 0*0 or 1*1 exists in the source code. Due to the fact that the size of the iframe is 0*0 or 1*1, the iframe is invisible. Other pages are opened via the iframe, and therefore a user opens a web page which is not expected to be opened, and traffic or the page views is brushed under the condition of invisibility. An analysis program can be compiled to analyse whether the iframe has a size of 0*0 or 1*1 exists in the source code.

Step S603: If the iframe does not exist in the source code, the page views of the target web page is acquired. When the iframe does not exist in the source code, next judgment is performed by acquiring the page views of the target web page. If the iframe exists in the source code, it is determined that the page views of the target web page is cheated. Due to the fact that the iframe has a size of 0*0 or 1*1 is used for cheating the page views and the page views is brushed under the condition that the user is not informed, when it is detected that the iframe exists in the source code of the target web page, it can be considered that a cheat way is adopted, so it can be determined that the page views of the target web page is cheated.

Step S604: It is judged whether the page views satisfies a predetermined condition.

Step S605: If the page views satisfies the predetermined condition, visit source information of the target web page is acquired.

Step S606: It is judged whether the page views of the target web page is cheated according to the visit source information.

Step S603 of acquiring the page views of the target web page, Step S604, Step S605 and Step S606 are identical to Step S101, Step S102, Step S103 and Step S104 of the method for detecting cheat on web page views shown in FIG. 7, which do not need to be described in detail here.

The above is only the preferred embodiments of the invention, and is not intended to limit the disclosure. There can be various modifications and variations in the disclosure for those skilled in the art. Any modifications, equivalent replacements, improvements and the like within the spirit and principle of the disclosure shall fall within the protection scope of the invention.

What is claimed is:

1. A method for detecting cheat on web page views, comprising:
acquiring page views of a target web page;
judging whether the page views satisfies a predetermined condition;
acquiring visit source information of the target web page if the page views satisfies the predetermined condition; and
judging whether the page views of the target web page is cheated according to the visit source information.

2. The method for detecting cheat on web page views according to claim 1, wherein acquiring the page views of the target web page comprises acquiring historical page views and current page views to the target web page, and judging whether the page views satisfies the predetermined condition comprises:
acquiring a ratio of the historical page views to the current page views;
judging whether the ratio exceeds a first set threshold value;
determining that the page views satisfies the predetermined condition if the ratio exceeds the first set threshold value; and
determining that the page views does not satisfy the predetermined condition if the ratio does not exceed the first set threshold value.

3. The method for detecting cheat on web page views according to claim 1, wherein acquiring the page views of the target web page comprises acquiring historical page views and current page views to the target web page, and judging whether the page views satisfies the predetermined condition comprises:
acquiring a difference between the historical page views and the current page views;
judging whether the difference exceeds a second set threshold value;
determining that the page views satisfies the predetermined condition if the difference exceeds the second set threshold value; and
determining that the page views does not satisfy the predetermined condition if the difference does not exceed the second set threshold value.

4. The method for detecting cheat on web page views according to claim 1, wherein
acquiring the visit source information of the target web page comprises: acquiring a source code of the target web page; adding a detection code to the source code so as to acquire visit Internet Protocol (IP) addresses of the target web page; and taking the visit IP addresses as the visit source information;
judging whether the page views of the target web page is cheated according to the visit source information comprises: acquiring a first number of visits of a first visit IP address among the visit IP addresses, the first visit IP address being a visit IP address, with most page views of the target web page, among the visit IP addresses;
calculating a ratio of the first page views of the page views;
judging whether the ratio of the first page views of the page views exceeds a third set threshold value;
determining that the page views of the target web page is cheated if the ratio of the first page views of the page views exceeds the third set threshold value; and
determining that the page views of the target web page is not cheated if the ratio of the first page views of the page views does not exceed the third set threshold value.

5. The method for detecting cheat on web page views according to claim 4, wherein determining that the page views of the target web page is cheated comprises:
acquiring visit retention time of the first visit IP address;
judging whether the visit retention time exceeds a fourth set threshold value; and
determining that the page views of the target web page is cheated if the visit retention time does not exceed the fourth set threshold value.

6. The method for detecting cheat on web page views according to claim 1, wherein before the page views of the target web page is acquired, the method for detecting cheat on web page views further comprises:
acquiring a source code of the target web page;
detecting whether an iframe has a size of 0*0 or 1*1 exists in the source code; and
acquiring the page views of the target web page if the iframe does not exist in the source code.

7. An apparatus for detecting cheat on web page views, comprising:
a first acquisition unit, configured to acquire the page views of a target web page;
a first judgement unit, configured to judge whether the page views satisfies a predetermined condition;
a second acquisition unit, configured to acquire visit source information of the target web page when the page views satisfies the predetermined condition; and
a second judgement unit, configured to judge whether the page views of the target web page is cheated according to the visit source information.

8. The apparatus for detecting cheat on web page views according to claim 7, wherein the first acquisition unit is further configured to acquire historical page views and current page views to the target web page, and the first judgement unit comprises:
a first acquisition module, configured to acquire a ratio of historical page views to current page views;
a first judgment module, configured to judge whether the ratio exceeds a first set threshold value; and
a first determination module, configured to determine that the page views satisfies the predetermined condition when the ratio exceeds the first set threshold value, and determine that the page views does not satisfy the predetermined condition when the ratio does not exceed the first set threshold value.

9. The apparatus for detecting cheat on web page views according to claim 7, wherein the first acquisition unit is further configured to acquire historical page views and current page views to the target web page, and the first judgement unit comprises:
a second acquisition module, configured to acquire a difference between historical page views and current page views;
a second judgment module, configured to judge whether the difference exceeds a second set threshold value; and
a second determination module, configured to determine that the page views satisfies the predetermined condition when the difference exceeds the second set threshold value, and determine that the page views does not satisfy the predetermined condition when the difference does not exceed the second set threshold value.

10. The apparatus for detecting cheat on web page views according to claim 7, wherein
the second acquisition unit comprises:
a third acquisition module, configured to acquire a source code of the target web page;
a fourth acquisition module, configured to add a detection code to the source code so as to acquire visit Internet Protocol (IP) addresses of the target web page; and
a generation module, configured to take the visit IP addresses as the visit source information;
the second judgment unit comprises:
a fifth acquisition module, configured to acquire a first number of visits of a first visit IP address among the visit IP addresses, the first visit IP address being a visit IP address, with most page views of the target web page, among the visit IP addresses;
a calculation module, configured to calculate a ratio of the first page views of the page views;
a third judgment module, configured to judge whether the ratio of the first page views of the page views exceeds a third set threshold value; and
a third determination module, configured to determine that the page views of the target web page is cheated when the ratio of the first page views of the page views exceeds the third set threshold value, and determine that the page views of the target web page is not cheated when the ratio of the first page views of the page views does not exceed the third set threshold value.

11. The apparatus for detecting cheat on web page views according to claim 10, wherein the third determination module comprises:
an acquisition sub-module, configured to acquire visit retention time of the first visit IP address;
a judgment sub-module, configured to judge whether the visit retention time exceeds a fourth set threshold value; and
a determination sub-module, configured to determine that the page views of the target web page is cheated when the visit retention time does not exceed the fourth set threshold value, and determine that the page views of the target web page is not cheated when the visit retention time exceeds the fourth set threshold value.

12. The apparatus for detecting cheat on web page views according to claim 7, further comprising:
a third acquisition unit, configured to acquire a source code of the target web page before the page views of the target web page is acquired;
a detection unit, configured to detect whether an iframe has a size of WO or 1*1 exists in the source code; and
a determination unit, configured to acquire the page views of the target web page when the iframe does not exist in the source code.
